(19) United States
(12) Patent Application Publication
(10) Pub. No.: US 2014/0219166 A1
(43) Pub. Date: Aug. 7, 2014

(54) RECEIVED DATA PROCESSING APPARATUS AND METHOD OF PROCESSING THE SAME

(71) Applicant: KABUSHIKI KAISHA TOSHIBA, Minato-ku (JP)

(72) Inventor: Yasuyuki Morikawa, Kanagawa-ken (JP)

(73) Assignee: KABUSHIKI KAISHA TOSHIBA, Minato-ku (JP)

(21) Appl. No.: 13/975,956

(22) Filed: Aug. 26, 2013

(30) Foreign Application Priority Data
Feb. 1, 2013 (JP) 2013-018604

(51) Int. Cl. H04L 12/861; H04W 4/00; H04W 40/00

(52) U.S. Cl. CPC H04L 49/9047; H04W 40/00; H04L 49/9042; H04W 4/008
USPC 370/328

(57) ABSTRACT

According to one embodiment, a received data processing apparatus includes a FIFO memory, a forwarding designation unit, and an output processing unit. The FIFO memory stores received data in reception order. The forwarding designation unit analyzes an ID added to the received data having reached a head of the FIFO memory, and outputs a forwarding designation signal that indicates a forwarding destination in the case where there is designation of the forwarding destination, and indicates non-designation in the case where there is no designation of a forwarding destination. The output processing unit performs output processing of the received data having reached the head of the FIFO memory based on the forwarding designation signal.

### CROSS REFERENCE TO RELATED APPLICATION

This application is based upon and claims the benefit of priority from the prior Japanese Patent Application No. 2013-018604, filed on Feb. 1, 2013, the entire contents of which are incorporated herein by reference.

### FIELD

Embodiments described herein relate to a received data processing apparatus and a method of processing the same.

### BACKGROUND

In recent years, a proximity wireless communication technology capable of forwarding data such as music, images, and moving images at a high speed has been put into practical use. In forwarding data using the proximity wireless communication technology, received data is once stored in a receive buffer, and is then forwarded to a destination of data processing. As the receive buffer, a FIFO memory is used, for example.

An ID is provided to each data, and in forwarding the data from the received buffer, the data is forwarded to a designated forwarding destination associated with the ID of the data.

However, there may be data with an ID that is not associated with a forwarding destination in the received data. When the above-described data is stored in the FIFO memory that is the receive buffer, there is no output destination of the FIFO memory, and thus, the data cannot be moved within the FIFO memory.

As a result, even if data having an ID including designation of a forwarding destination of the data is stored in the FIFO memory as subsequent data, the data cannot be taken out of the FIFO memory, resulting in a problem of occurrence of a communication error.

### BRIEF DESCRIPTION OF THE DRAWINGS

FIG. 1 is a block diagram illustrating a configuration of a received data processing apparatus according to a first embodiment;

FIG. 2 is a flowchart illustrating a method of processing received data in the received data processing apparatus according to the first embodiment;

FIG. 3 is a block diagram illustrating a configuration of a received data processing apparatus according to a second embodiment; and

FIG. 4 is a flowchart illustrating a method of processing received data in the received data processing apparatus according to the second embodiment.

### DETAILED DESCRIPTION

According to one embodiment, a received data processing apparatus includes a FIFO memory, a forwarding designation unit, and an output processing unit. The FIFO memory stores received data in reception order. The forwarding designation unit analyzes an ID added to the received data having reached a head of the FIFO memory, and outputs a forwarding designation signal that indicates a forwarding destination in the case where there is designation of the forwarding destination, and indicates non-designation in the case where there is no designation of a forwarding destination. The output processing unit performs output processing of the received data having reached the head of the FIFO memory based on the forwarding designation signal.

Hereinafter, a plurality of embodiments will be described with reference to the drawings. In the drawings, the same reference signs indicate the same or similar portions.

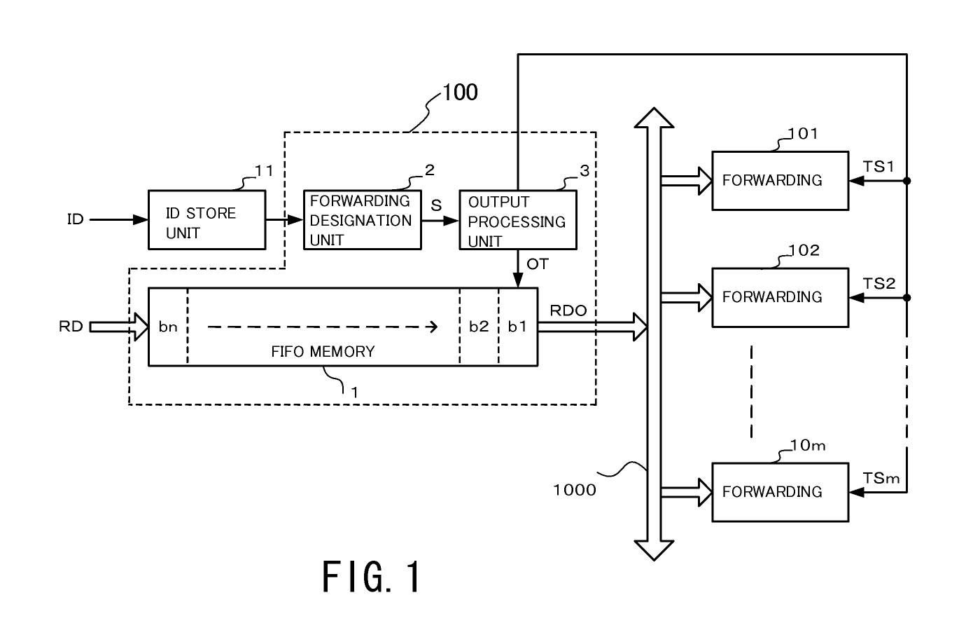

A received data processing apparatus and a method of processing received data according to a first embodiment will be described with reference to the drawings. FIG. 1 is a block diagram illustrating a configuration of a received data processing apparatus.

As illustrated in FIG. 1, a received data processing apparatus 100 includes a FIFO memory 1, a forwarding designation unit 2, and an output processing unit 3. The FIFO memory 1 stores received data RD in reception order. The forwarding designation unit 2 analyzes an ID added to the received data having reached a head b1 of the FIFO memory 1. The forwarding designation unit 2 outputs a forwarding designation signal S that indicates a forwarding destination in the case where there is designation of the forwarding destination, and indicates non-designation in the case where there is no designation of a forwarding destination. The output processing unit 3 performs output processing of the received data having reached the head b1 of the FIFO memory 1 based on the forwarding designation signal S.

The FIFO memory 1 is used as a receive buffer in proximity wireless communication, for example. The FIFO memory 1 has a capacity in which n pieces of received data RD are stored. The received data RD input to a terminal end bn of the FIFO memory 1 is sequentially moved to the head b1 of the FIFO memory 1. Here, the received data RD having reached the head b1 of the FIFO memory 1 is called output data RDO of the FIFO memory 1.

Note that the ID is individually added to the received data RD, and the ID is stored in an ID store unit 11 separately from the received data RD.

The forwarding designation unit 2 reads out the ID added to the output data RDO of the FIFO memory 1 from the ID store unit 11, and analyzes the ID.

The forwarding designation unit 2 outputs the forwarding designation signal S based on a result of the ID analysis. The forwarding designation signal S indicates a forwarding destination if the ID has designation of the forwarding destination, and indicates non-designation if the ID has no designation of a forwarding destination.

The output processing unit 3 performs output processing of the output data RDO of the FIFO memory 1 based on the forwarding designation signal S.

At this time, the output processing unit 3 outputs the output data RDO to the designated forwarding destination when the forwarding designation signal S indicates the forwarding destination.

The forwarding of the output data RDO is executed through a bus 1000. The output processing unit 3 outputs the output data RDO of the FIFO memory 1 to the bus 1000 and outputs data receiving instruction signals TS1 to TSm to m-forwarding destinations 101 to 10m connected to the bus 1000.

The data receiving instruction signals TS1 to TSm instruct any one of the forwarding destinations 101 to 10m to receive the output data RDO of the FIFO memory 1 from the bus 1000.

Meanwhile, when the forwarding designation signal indicates non-designation, the output processing unit 3 reads and throws the output data RDO of the FIFO memory 1.

In the case of a read and throw operation, the output processing unit 3 only outputs the output data RDO of the FIFO memory 1 to the bus 1000, and does not output the output data RDO to the data receiving instruction signals TS1 to TSm. Therefore, the data output to the bus 1000 disappears at the time of an output of next data to the bus 1000.

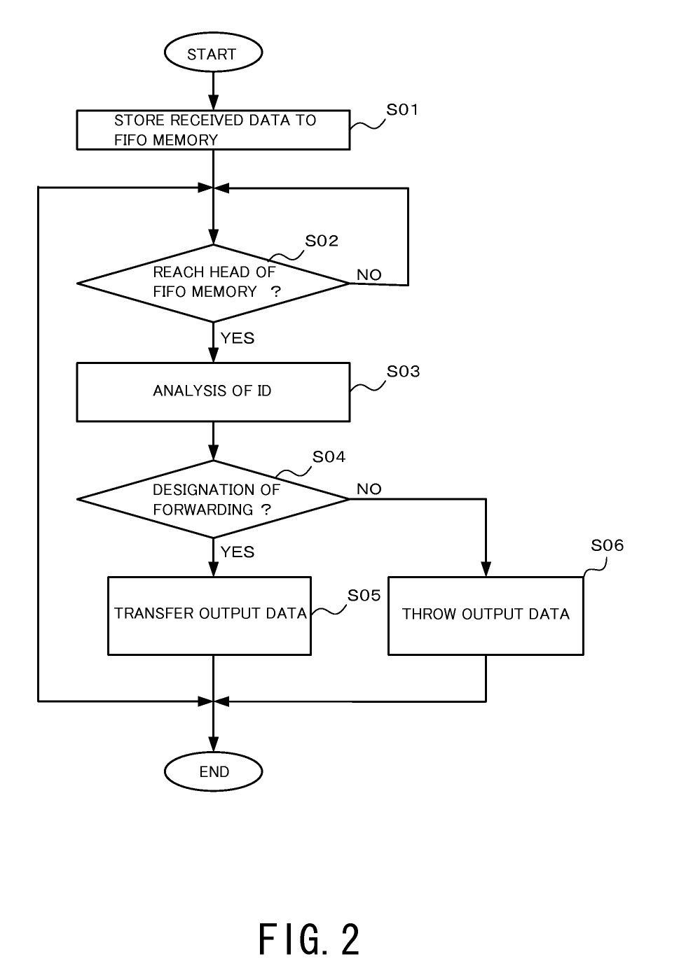

Next, a flow of processing of the received data will be described with reference to FIG. 2. FIG. 2 is a flowchart illustrating a method of processing the received data in the received data processing apparatus.

As illustrated in FIG. 2, the received data RD is sequentially stored in the FIFO memory 1 (step S01). Whether the received data RD has reached the head b1 of the FIFO memory 1 is checked until when the received data RD reaches the head b1 (step S02).

When the received data RD has reached the head b1 of the FIFO memory 1 (YES), the forwarding designation unit 2 reads out the ID added to the output data RDO of the FIFO memory 1 from the ID store unit 11, and analyzes the ID (step S03). Whether designation of a forwarding destination is included in the ID is checked (step S04). When the received data RD has not reached the head b1 of the FIFO memory 1 (NO), the processing returns to step S02.

When the ID has designation of a forwarding destination (YES), the output processing unit 3 forwards the output data RDO of the FIFO memory 1 to the designated forwarding destination (step S05).

Meanwhile, when the ID has no designation of a forwarding destination (NO), the output processing unit 3 reads and throws the output data RDO of the FIFO memory 1 to the bus 1000 (step S06).

The operations of steps S02 to S06 are hereafter repeated.

As described above, in the received data processing apparatus and the method of processing received data of the present embodiment, when the ID added to the received data having reached the head of the FIFO memory 1 has no designation of a forwarding destination, the received data can be read and thrown from the FIFO memory 1. Therefore, the received data can be moved within the FIFO memory 1, and subsequent received data having designation of a forwarding destination in the ID can be taken out of the FIFO memory 1. Therefore, occurrence of a communication error can be prevented.

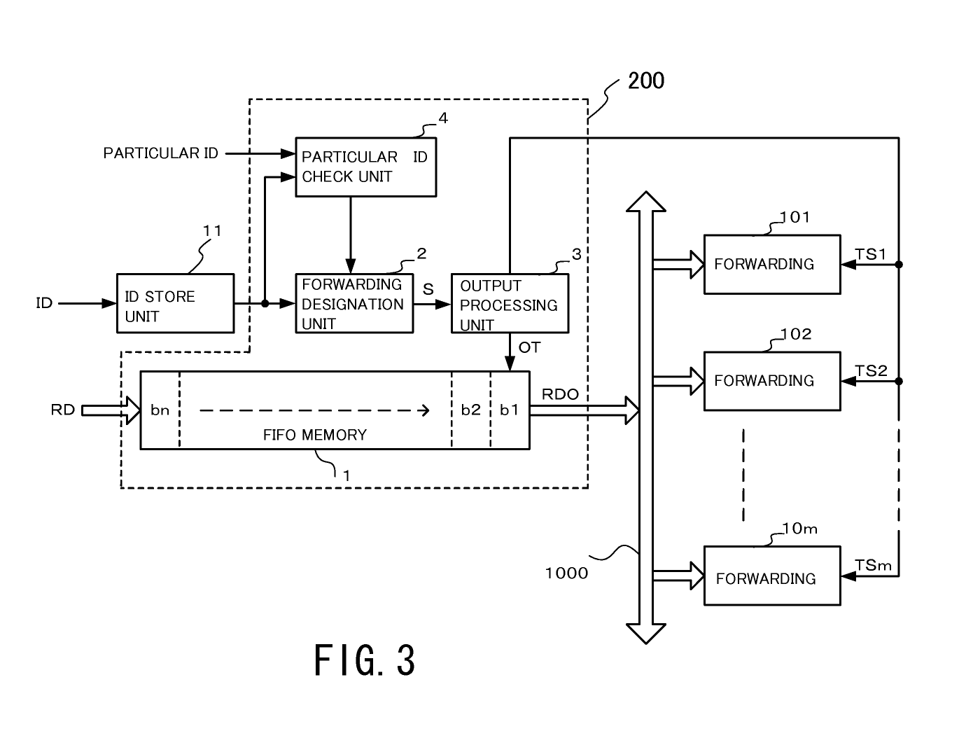

A received data processing apparatus and a method of processing received data according to a second embodiment will be described with reference to the drawings. FIG. 3 is a block diagram illustrating a configuration of a received data processing apparatus.

As illustrated in FIG. 3, a received data processing apparatus 200 has a particular ID check unit 4 in addition to the received data processing apparatus 100 of the first embodiment. The same configurations as the first embodiment are denoted with the same reference signs, and description is omitted.

The particular ID check unit 4 checks whether an ID of output data RDO of a FIFO memory 1 coincides with a predetermined particular ID.

When the particular ID check unit 4 detects that the ID of the output data RDO of the FIFO memory 1 coincides with the particular ID, the particular ID check unit 4 instructs a forwarding designation unit 2 to cause a forwarding designation signal S to indicate non-designation.

When the ID of the output data RDO of the FIFO memory 1 coincides with the predetermined particular ID, the output data RDO is read and thrown to a bus 1000.

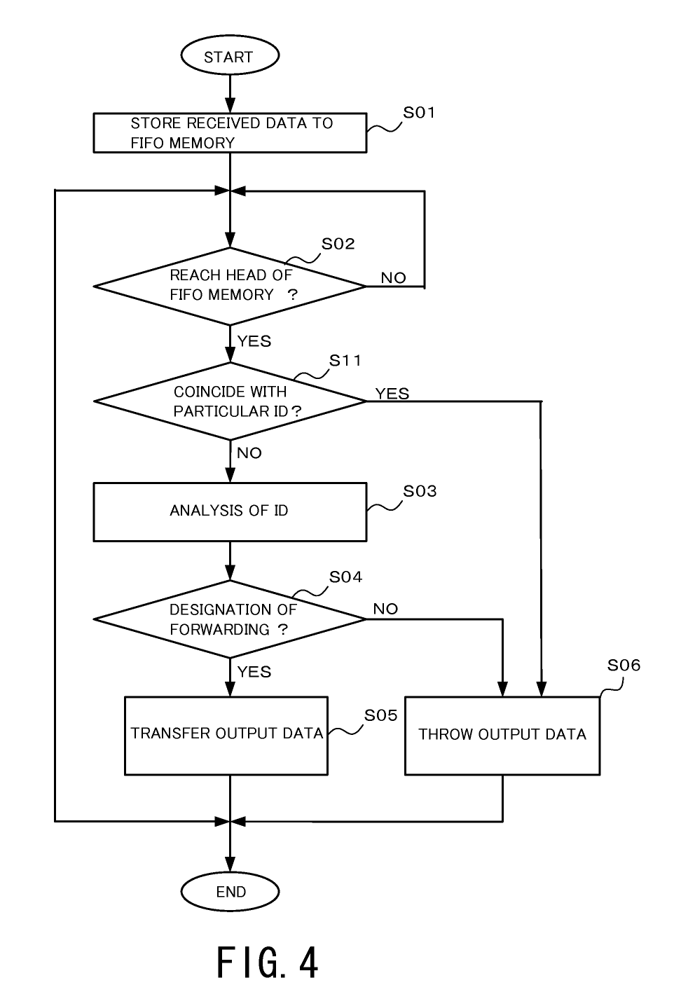

Next, a flow of processing of the received data will be described with reference to FIG. 4. FIG. 4 is a flowchart illustrating a flow of processing of the received data in the received data processing apparatus.

The flow illustrated in FIG. 4 adds processing of step S11 between step S02 and step S03 of the flow illustrated in FIG. 2. The same processing as the flow of FIG. 2 is denoted with the same reference signs and description is omitted.

In processing at step S11, the particular ID check unit 4 checks whether the ID of the output data RDO of the FIFO memory 1 coincides with the predetermined particular ID.

When it is detected that the ID of the output data RDO of the FIFO memory 1 coincides with the particular ID in the above-described check (YES), the output data RDO of the FIFO memory 1 is read and thrown to the bus 1000 (step S06).

Meanwhile, when the ID of the output data RDO of the FIFO memory 1 does not coincide with the particular ID (NO), the process proceeds to step S03, and an analysis of the ID is performed.

As described above, in the received data processing apparatus and the method of processing received data, the received data of the particular ID can be read and thrown from the FIFO memory, the capacity of the FIFO memory can be reduced.

According to the received data processing apparatus and the method of processing received data of at least one of the embodiments described above, even if a forwarding destination is not associated with an ID of data stored in a receive buffer in a FIFO format, occurrence of a communication error can be prevented.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A received data processing apparatus comprising:
a FIFO memory to store received data in reception order;
a forwarding designation unit to analyze an ID added to the received data having reached a head of the FIFO memory, and to output a forwarding designation signal indicating a forwarding destination in the case where there is designation of the forwarding destination and indicating non-designation in the case where there is no designation of a forwarding destination; and
an output processing unit to perform output processing of the received data having reached the head of the FIFO memory based on the forwarding designation signal.

2. The apparatus according to claim 1, wherein the output processing unit
outputs the received data having reached the head of the FIFO memory to the forwarding destination when the forwarding designation signal indicates the forwarding destination, and
reads and throws the received data having reached the head of the FIFO memory when the forwarding designation signal indicates the non-designation.

3. The apparatus according to claim 1, wherein the forwarding designation unit reads out the ID stored in an ID store unit and added to the received data.

4. The apparatus according to claim 1, further comprising:
a particular ID check unit to check whether the ID coincides with a predetermined particular ID,
wherein, when the particular ID check unit detects the ID being coincided with the predetermined particular ID, the particular ID check unit instructs the forwarding designation unit to cause the forwarding designation signal to indicate non-designation.

5. The apparatus according to claim 4, wherein the forwarding designation unit and the particular ID check unit read out the ID stored in an ID store unit and added to the received data.

6. The apparatus according to claim 1, wherein the FIFO memory is used as a receive buffer in a proximity wireless communication.

7. The apparatus according to claim 1, wherein output data of the FIFO memory is output to the forwarding destination through a bus.

8. A method of processing received data comprising:
storing the received data in a FIFO memory in reception order;
analyzing an ID added to the received data having reached a head of the FIFO memory, and outputting a forwarding designation signal indicating a forwarding destination in the case where there is designation of the forwarding destination and indicating non-designation in the case where there is no designation of a forwarding destination; and
performing output processing of the received data having reached the head of the FIFO memory based on the forwarding designation signal.

9. The method according to claim 8, further comprising:
checking whether the ID coincides with a predetermined particular ID,
wherein, when the ID being coincided with the predetermined particular ID is detected , the forwarding designation signal is caused to indicate non-designation.

10. The method according to claim 8, wherein the received data having reached the head of the FIFO memory is output to the forwarding destination when the forwarding designation signal indicates the forwarding destination, and
the received data having reached the head of the FIFO memory is read and thrown when the forwarding designation signal indicates the non-designation.
